(19) United States
(12) Patent Application Publication
(10) Pub. No.: US 2022/0076148 A1
(43) Pub. Date: Mar. 10, 2022

(54) INFORMATION PROCESSING DEVICE AND INFORMATION PROCESSING METHOD

(71) Applicant: Kioxia Corporation, Tokyo (JP)

(72) Inventor: Shinichiro MANABE, Yokohama (JP)

(73) Assignee: Kioxia Corporation, Tokyo (JP)

(21) Appl. No.: 17/191,032

(22) Filed: Mar. 3, 2021

(30) Foreign Application Priority Data
Sep. 7, 2020 (JP) 2020-150056

(51) Int. Cl. G06N 5/04; G06F 17/18

(52) U.S. Cl. CPC G06N 5/04; G06F 17/18

(57) ABSTRACT

An information processing device has an inputter configured to input analysis target data including a plurality of explanatory variables, a screening processor configured to generate intermediate data with the number of the explanatory variables included in the analysis target data reduced by using a part of the plurality of explanatory variables as objective variables, a first feature amount extractor configured to extract a first feature amount from the intermediate data based on the objective variables, and a similar feature amount extractor configured to extract a similar feature amount from the intermediate data based on a degree of similarity between the explanatory variables included in the intermediate data and the first feature amount.

### CROSS REFERENCE TO RELATED APPLICATIONS

This application is based upon and claims the benefit of priority from the prior Japanese Patent Application No. 2020-150056, filed on Sep. 7, 2020, the entire contents of which are incorporated herein by reference.

### FIELD

One embodiment of the present disclosure relates to an information processing device and an information processing method.

### BACKGROUND

A regression model with penalty terms has been proposed as a method for extracting a feature amount from a large amount of data (big data). This regression model has a problem that a feature amount similar to one selected as an explanatory variable cannot be extracted. Therefore, there is a problem that important factors included in big data can be easily overlooked.

Further, the work of extracting a feature amount or a similar feature amount from big data depends on a data size of the big data, and the larger the data size, the longer the extraction work takes.

### BRIEF DESCRIPTION OF THE DRAWINGS

FIG. 1 is a block diagram illustrating a schematic configuration of an information processing device according to a first embodiment of the present disclosure;

FIG. 2 is a diagram schematically illustrating a feature amount and a similar feature amount;

FIG. 3 is a diagram schematically illustrating a processing operation of the information processing device according to the first embodiment;

FIG. 4 is a block diagram illustrating a schematic configuration of an information processing device according to a second embodiment;

FIG. 5 is a diagram schematically illustrating a processing operation of the information processing device according to the second embodiment;

FIG. 6 is a diagram illustrating processing operations of a screening processing unit and a feature amount extraction unit according to the second embodiment;

FIG. 7 is a flowchart illustrating the processing operation of the information processing device according to the second embodiment;

FIG. 8 is a detailed flowchart of processing procedures performed by a characteristic analysis unit in steps S2 and S10 of FIG. 7;

FIG. 9 is a detailed flowchart of a processing procedure performed by a determination processing unit in step S16 of FIG. 7,

FIG. 10 is a diagram illustrating results of extracting a similar feature amount from big data related to a semiconductor process by the information processing device according to the second embodiment;

FIG. 11A is a diagram illustrating a model accuracy of a screening method (Iterative Sure Independence Screening: IDSIS) according to the present embodiment; and

FIG. 11B a diagram illustrating the model accuracy of the ISIS for screening only once.

### DETAILED DESCRIPTION

According to one embodiment, an information processing device has an inputter configured to input analysis target data including a plurality of explanatory variables, a screening processor configured to generate intermediate data with the number of the explanatory variables included in the analysis target data reduced by using a part of the plurality of explanatory variables as objective variables, a first feature amount extractor configured to extract a first feature amount from the intermediate data based on the objective variables, and a similar feature amount extractor configured to extract a similar feature amount from the intermediate data based on a degree of similarity between the explanatory variables included in the intermediate data and the first feature amount.

Hereinafter, embodiments of an information processing device will be described with reference to the drawings. In the following, main components of the information processing device will be mainly described, but the information processing device may have components and functions not illustrated in the drawings or described. The following descriptions do not exclude components or functions not illustrated in the drawings or described.

### First Embodiment

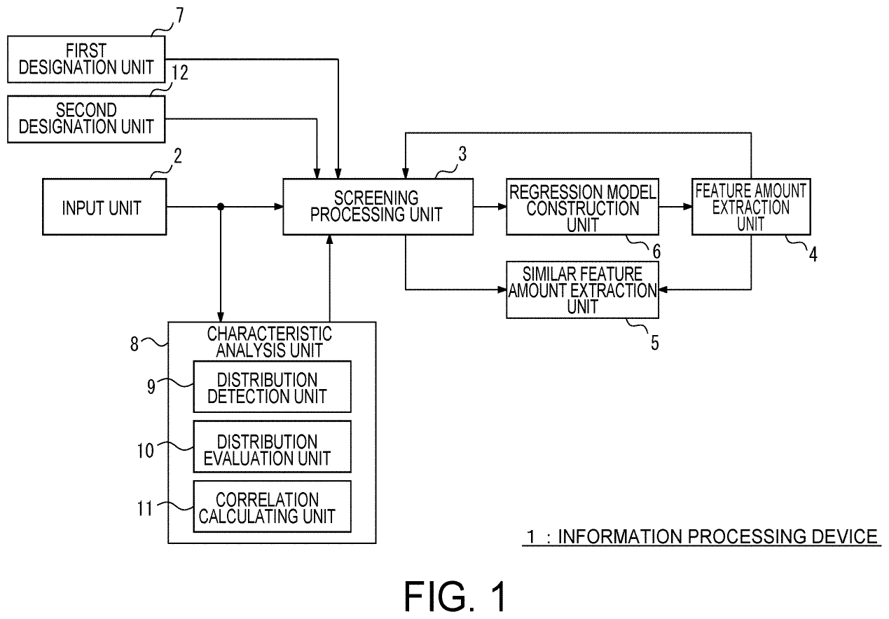

FIG. 1 is a block diagram illustrating a schematic configuration of an information processing device 1 according to a first embodiment of the present disclosure. The information processing device 1 of FIG. 1 includes an input unit 2, a screening processing unit 3, a feature amount extraction unit 4, and a similar feature amount extraction unit 5.

The input unit 2 inputs analysis target data including a plurality of explanatory variables. Specific contents of the analysis target data are not considered, but they are, for example, a large amount of data (big data) exceeding tens of thousands of dimensions. Individual data in the analysis target data are also called explanatory variables. In addition, some of the explanatory variables are called objective variables. In the present embodiment, it is intended to perform processing for selecting an explanatory variable that affects an objective variable from the explanatory variables. As a specific example, the analysis target data may be data generated in a manufacturing process of a semiconductor factory or may be other data.

The screening processing unit 3 uses a part of the explanatory variables as the objective variable and generates intermediate data generated by reducing the number of explanatory variables included in the analysis target data. More specifically, the screening processing unit 3 generates the intermediate data in which some explanatory variables are deleted from the analysis target data so as not to lose a feature amount. Therefore, although the number of data is less than that of the analysis target data, the intermediate data contain a feature amount comparable to the analysis target data. For example, the screening processing unit 3 generates the intermediate data narrowed down to several thousand dimensions when the analysis target data have more than tens of thousands of dimensions. It is arbitrary how much the screening processing unit 3 reduces the analysis target data to generate the intermediate data.

The feature amount extraction unit 4 extracts the feature amount from the intermediate data based on the objective variable. A feature amount is an explanatory variable that affects the objective variable included in the analysis target data. That is, the feature amount is an explanatory variable having a high degree of correlation with the objective variable. As will be described later, in the present specification, the feature amount extracted by the feature amount extraction unit 4 may be referred to as a first feature amount, and the feature amount extraction unit 4 may be referred to as a first feature amount extraction unit. The degree of correlation is represented by a correlation value as described later, and the larger the correlation value, the higher the degree of correlation.

The similar feature amount extraction unit 5 extracts the similar feature amount from the intermediate data based on a degree of similarity between the explanatory variables included in the intermediate data and the feature amount.

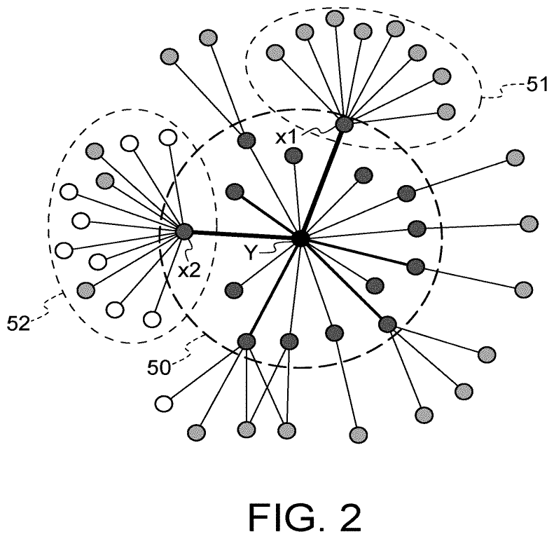

FIG. 2 is a diagram schematically illustrating the feature amount and the similar feature amount. An objective variable Y is located in a center of FIG. 2, and explanatory variables X1 and X2, which are feature amounts affecting the objective variable Y, are arranged around a periphery 50 of the objective variable Y. In addition, explanatory variables, which are similar feature amounts that affect each explanatory variable, are arranged around a periphery of each explanatory variable. Black circles in FIG. 2 indicate the explanatory variables that are feature amounts, and white circles and gray circles are the explanatory variables that are similar feature amounts. Explanatory variables, which are similar feature amounts affecting the explanatory variables X1 and X2, are present around peripheries 51 and 52 of the explanatory variables X1 and X2 that are the feature amounts in FIG. 2. As illustrated in FIG. 2, it can be said that the explanatory variables that are similar feature amounts affect not only the explanatory variables that are the feature amounts but also the objective variable Y. Therefore, the similar feature amount extraction unit 5 in FIG. 1 extracts the similar feature amounts from the intermediate data.

The information processing device 1 of FIG. 1 may include a regression model construction unit 6. The regression model construction unit 6 constructs a regression model that calculates the feature amounts by regression analysis of the objective variables and the intermediate data. In this case, the feature amount extraction unit 4 extracts the feature amounts from the intermediate data based on the regression model. For example, when the analysis target data are data generated in a manufacturing process of a semiconductor factory, the feature amount extraction unit 4 and the similar feature amount extraction unit 5 extract feature amounts and similar feature amounts that cause fluctuations in certain characteristic values in the manufacturing process. By using the extracted feature amounts and similar feature amounts, factors affecting a quality of a semiconductor can be identified.

The information processing device 1 of FIG. 1 may include a first designation unit 7. The first designation unit 7 specifies a size of the intermediate data. The screening processing unit 3 generates the intermediate data according to the data size specified by the first designation unit 7. In this way, by specifying the size of the intermediate data in the first designation unit 7, the data size of the intermediate data can be arbitrarily adjusted according to an intention of a user.

The information processing device 1 of FIG. 1 may include a characteristic analysis unit 8. The characteristic analysis unit 8 extracts characteristic data from the analysis target data. The characteristic data are data illustrating the degree of correlation between the explanatory variables and the objective variables included in the analysis target data. The characteristic data are used to adjust the number of explanatory variables in the intermediate data generated by the screening processing unit 3. That is, the screening processing unit 3 generates the intermediate data having a data size corresponding to the characteristic data based on the analysis target data and the characteristic data.

The characteristic analysis unit 8 described above may have a distribution detection unit 9, a distribution evaluation unit 10, and a correlation calculating unit 11.

The distribution detection unit 9 detects distribution of the explanatory variables included in the analysis target data. The distribution evaluation unit 10 evaluates the distribution of the explanatory variables detected by the distribution detection unit 9. The correlation calculating unit 11 extracts the characteristic data based on the evaluation result of the distribution evaluation unit 10.

The information processing device 1 of FIG. 1 may include a second designation unit 12. The second designation unit 12 specifies the characteristic data extracted by the characteristic analysis unit 8.

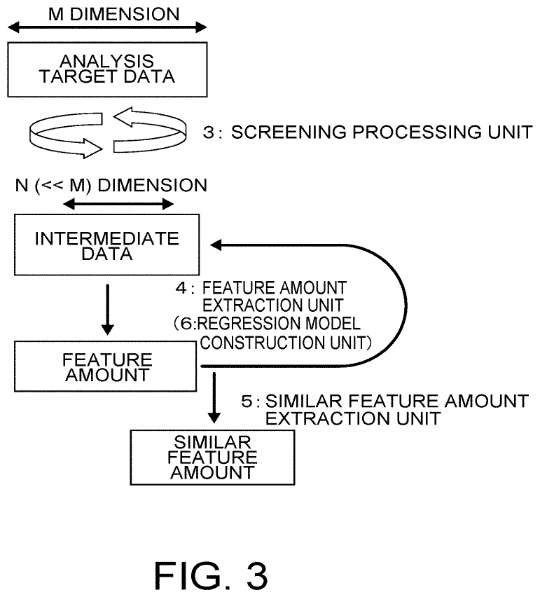

FIG. 3 is a diagram schematically illustrating a processing operation of the information processing device 1 according to the first embodiment. The information processing device 1 of FIG. 3 inputs, for example, analysis target data having more than tens of thousands of dimensions to the screening processing unit 3. The screening processing unit 3 generates, for example, intermediate data having several thousand dimensions from the number of analysis target data having more than tens of thousands of dimensions. The screening processing unit 3 generates the intermediate data from the analysis target data while maintaining the feature amounts according to the specification of the first designation unit 7.

The regression model construction unit 6 extracts the feature amounts contained in the intermediate data by using a sparse modeling technique. Further, the similar feature amount extraction unit 5 extracts the similar feature amounts from the intermediate data based on the degree of similarity between the explanatory variables and the feature amounts included in the intermediate data. Calculation methods for extracting the similar feature amounts from the intermediate data are not particularly considered.

A mathematical formula of the regression model constructed by the regression model construction unit 6 is represented by, for example, formula (1).

y=Xβ(=β0+β1X1+ . . . +βpXp) (1)

The feature amounts extracted by the feature amount extraction unit 4 is obtained, for example, by using Lasso's mathematical formula illustrated in formula (2) below. That is, among the explanatory variables X, the explanatory variable X that minimizes an objective function by adding an L1 penalty term (right-hand side second term) to a mean square error (right-hand side first term) illustrated in the formula (2) is the feature amount.

\hat{β}^{LASSO}=^{argmin}_{β}∥y−Xβ|₂²+λ∥β∥₁(∥β∥₁=∥β∥+ . . . +|βₚ| (2)

The formula (1) is an example of a regression model, and the formula (2) is an example of a mathematical formula for obtaining the feature amounts. The feature amounts may be extracted using mathematical formulae other than the formulae (1) and (2).

As described above, in the first embodiment, the feature amounts are extracted based on the intermediate data generated by screening the analysis target data and significantly reducing the data size, and the similar feature amounts are extracted based on the degree of similarity between the explanatory variables included in the intermediate data and the feature amounts. Since the intermediate data are data whose data size is significantly smaller than that of the analysis target data while maintaining the feature amounts of the analysis target data, the similar feature amounts can be quickly extracted. In particular, since the intermediate data maintains the feature amounts of the analysis target data, the similar feature amounts can be extracted accurately without omission. By extracting the similar feature amounts, it is possible to extract important factors included in the analysis target data without overlooking them.

### Second Embodiment

In an information processing device 1a according to a second embodiment, the processing operation of the screening processing unit 3 is different from that of the first embodiment.

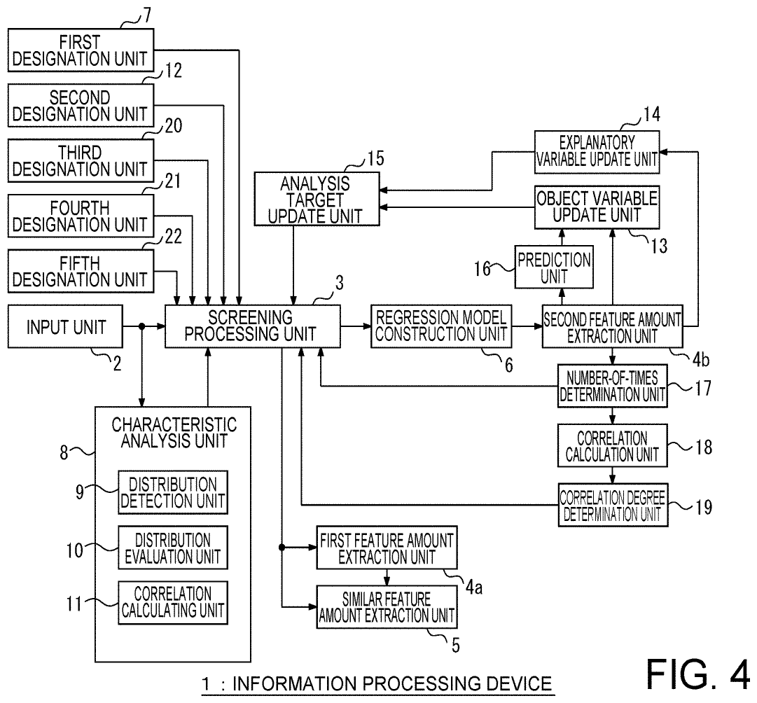

FIG. 4 is a block diagram illustrating a schematic configuration of the information processing device 1a according to the second embodiment. The information processing device 1a of FIG. 4 has some blocks added in addition to the block configuration of the information processing device 1 of FIG. 1, but these are not always essential. Further, in FIG. 4, one corresponding to the feature amount extraction unit 4 of FIG. 1 is referred to as a first feature amount extraction unit 4a, and further, a second feature amount extraction unit 4b is included separately from the first feature amount extraction unit 4a.

After the screening processing unit 3 finishes generating multiple intermediate data, the first feature amount extraction unit 4a extracts a plurality of feature amounts in association with the multiple intermediate data. The similar feature amount extraction unit 5 extracts similar feature amounts from the intermediate data corresponding to each of a plurality of first feature amounts. Each time the screening processing unit 3 generates new intermediate data, the second feature amount extraction unit 4b extracts a second feature amount based on the new intermediate data. The first feature amount is a feature amount that is finally extracted from the analysis target data, while the second feature amount is an intermediate feature amount that is extracted in a process of screening processing.

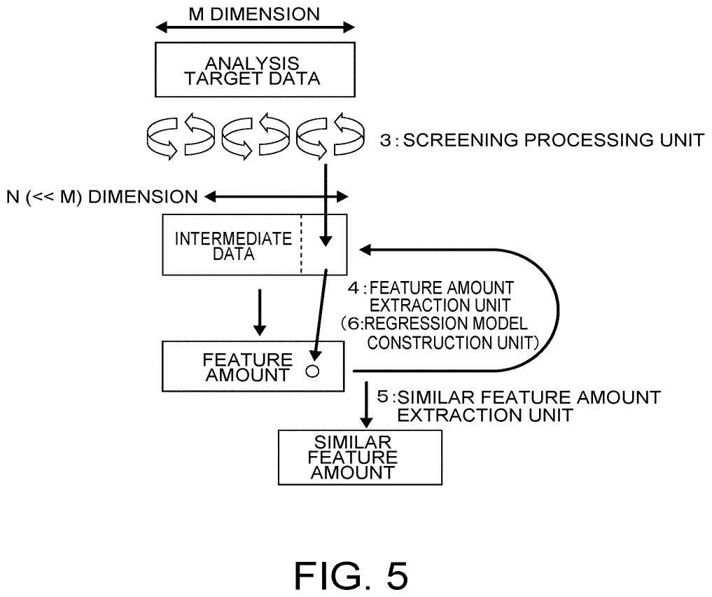

FIG. 5 is a diagram schematically illustrating a processing operation of the information processing device 1a according to the second embodiment. The screening processing unit 3 in the information processing device 1a of FIG. 5 repeats processing of generating the intermediate data from the analysis target data a plurality of times. In this way, since the intermediate data are generated in small pieces, individual intermediate data can be generated quickly.

The second feature amount extraction unit 4b extracts the second feature amount each time the screening processing unit 3 generates the intermediate data. More specifically, the second feature amount extraction unit 4b extracts the second feature amount included in the intermediate data based on the regression model constructed by the regression model construction unit 6 using the sparse modeling technique.

The information processing device 1a of FIG. 4 may include an objective variable update unit 13, an explanatory variable update unit 14, and an analysis target update unit 15.

The objective variable update unit 13 generates a new objective variable each time the second feature amount extraction unit 4b extracts the second feature amount. The explanatory variable update unit 14 generates a new explanatory variable each time the second feature amount extraction unit 4b extracts the second feature amount. The analysis target update unit 15 updates the analysis target data so as to include a new objective variable and a new explanatory variable. The screening processing unit 3 generates new intermediate data from the updated analysis target data.

The information processing device 1a of FIG. 4 may include a prediction unit 16. The prediction unit 16 predicts the objective variable based on the second feature amount extracted by the second feature amount extraction unit 4b. The objective variable update unit 13 generates a new objective variable based on a difference between an original objective variable and the predicted objective variable. The explanatory variable update unit 14 generates a new explanatory variable by a difference between an original explanatory variable and the explanatory variable included in the intermediate data.

The information processing device 1a of FIG. 4 may include a number-of-times determination unit 17, a correlation calculation unit 18, and a correlation degree determination unit 19. In the present specification, the number-of-times determination unit 17, the correlation calculation unit 18, and the correlation degree determination unit 19 are collectively referred to as a determination processing unit.

The number-of-times determination unit 17 determines whether the number-of-times the second feature amount has been extracted by the second feature amount extraction unit 4b has reached a predetermined number of times. The correlation calculation unit 18 calculates a correlation value between the new objective variable and the new analysis target data when it is determined that the predetermined number of times has not been reached. The correlation degree determination unit 19 determines whether the correlation value is equal to or greater than a predetermined threshold value. When the correlation value is equal to or higher than the predetermined threshold value, the screening processing unit 3 ends generation of the intermediate data, and when the correlation value is less than the threshold value, stops the generation of the intermediate data.

The information processing device 1a of FIG. 4 may include a third designation unit 20. The third designation unit 20 specifies the number of times the screening processing unit 3 generates the intermediate data.

The information processing device 1a of FIG. 4 may include a fourth designation unit 21. The fourth designation unit 21 specifies an explanatory variable to be selected each time the screening processing unit 3 generates the intermediate data.

The information processing device 1a of FIG. 4 may include a fifth designation unit 22. The fifth designation unit 22 specifies a lower limit value of the explanatory variable included in the intermediate data each time the screening processing unit 3 generates the intermediate data.

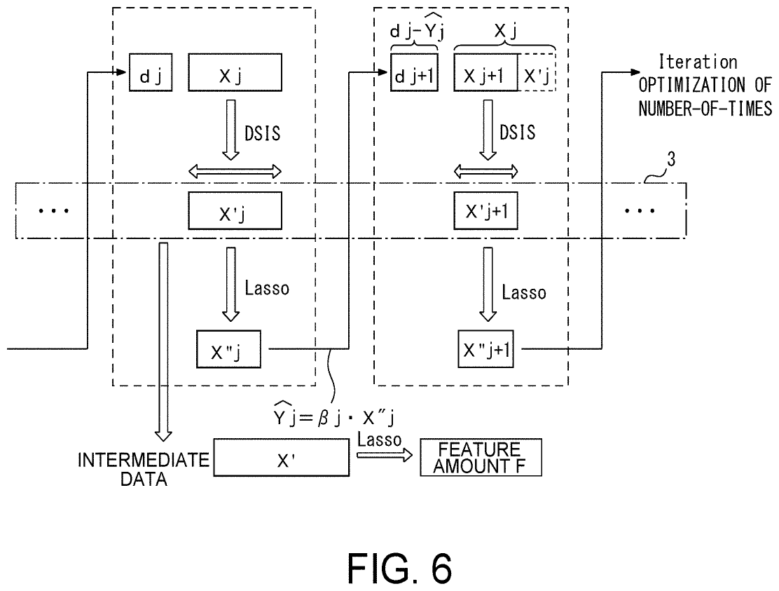

FIG. 6 is a diagram illustrating processing operations of the screening processing unit 3 and the second feature amount extraction unit 4b in the information processing device 1a according to the second embodiment. Broken line portions in FIG. 6 indicate processing units of the characteristic analysis unit 8, the screening processing unit 3, and the second feature amount extraction unit 4b. The characteristic analysis unit 8, the screening processing unit 3, and the second feature amount extraction unit 4b execute processings of the broken line portions a plurality of times.

In FIG. 6, dj is an objective variable, Xj is an explanatory variable, X′j is a piece of intermediate data, and X″j is a second feature amount. The characteristic analysis unit 8 evaluates distribution of the second feature amounts based on the objective variable dj and the explanatory variable Xj included in the analysis target data and extracts the characteristic data. The characteristic data are data for evaluating the distribution of the explanatory variables and are used to set the data size of the intermediate data.

The screening processing unit 3 generates the intermediate data X′j having the data size corresponding to the characteristic data. The second feature amount extraction unit 4b extracts the second feature amount X″j from the intermediate data X′j.

The processings of the broken line portions in FIG. 6 are also called Iterative Sure Independence Screening (IDSIS). Whether to continue or stop the processings of the broken line portions in FIG. 6 is determined by the determination processing unit including the number-of-times determination unit 17, the correlation calculation unit 18, and the correlation degree determination unit 19.

After the screening processing by the screening processing unit 3 is completed, the first feature amount extraction unit 4a extracts the first feature amount using all the intermediate data generated by the screening processing unit 3. At that time, the first feature amount extraction unit 4a examines how many times the screening processing unit 3 has extracted the extracted first feature amount from the intermediate data generated. The similar feature amount extraction unit 5 does not use all the intermediate data but extracts a similar feature amount from the intermediate data from which the individual first feature amount is extracted.

As a specific example, it is assumed that the screening processing unit 3 repeats the processing of generating the intermediate data three times. Assuming that the intermediate data generated by the screening processing unit 3 each time are “data 1”, “data 2”, and “data 3”, intermediate data “data” finally output by the screening processing unit 3 are data=“data 1”+“data 2”+“data 3”.

The first feature amount extraction unit 4a extracts the first feature amount from the intermediate data “data”. At this time, for example, it is assumed that four first feature amounts F1, F2, F3, and F4 are extracted. The first feature amount extraction unit 4a examines, for example, that the first feature amount F1 is extracted from the intermediate data “data 1”, the first feature amounts F2 and F3 are extracted from the intermediate data “data 2”, and the first feature amount F4 is extracted from the intermediate data “data 3”.

In this case, the similar feature amount extraction unit 5 extracts the similar feature amount of the first feature amount F1 from the intermediate data “data 1”, extracts the similar feature amounts of the first feature amounts F2 and F3 from the intermediate data “data 2”, and extracts the similar feature amount of the first feature amount F4 from intermediate data “data 3”.

In this way, by limiting a range in which the similar feature amount extraction unit 5 extracts the similar feature amount, a processing speed for extracting the similar feature amount can be improved.

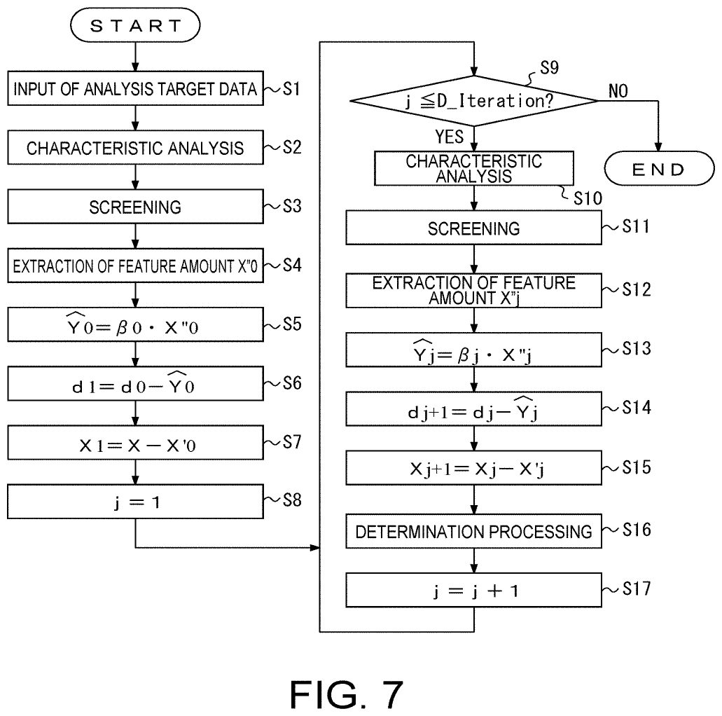

FIG. 7 is a flowchart illustrating the processing operation of the information processing device 1a according to the second embodiment. First, the analysis target data including the explanatory variable X and the objective variable Y are read (step S1).

Next, the characteristic analysis unit 8 extracts the characteristic data from the analysis target data (step S2). A detailed processing procedure of the characteristic analysis unit 8 will be described later.

Next, the screening processing unit 3 performs the screening processing based on the analysis target data and the characteristic data and generates intermediate data X′0 having the data size corresponding to the characteristic data (step S3). The analysis target data in step S3 are the analysis target data input in step S1, and X0=X and d0=Y.

Next, the second feature amount extraction unit 4b extracts a second feature amount X″0 from the intermediate data X′0 (step S4). The second feature amount extraction unit 4b extracts the second feature amount by, for example, the Lasso's mathematical formula of the above-mentioned formula (2).

Next, a linear prediction value Y0\hat{ } of the extracted second feature amount X″0 is calculated (step S5). The linear prediction value Y0″ is a value obtained by multiplying the second feature amount X″0 by a coefficient β0.

Next, an objective variable d1=d0−Y0\hat{ } is calculated (step S6). Next, an explanatory variable X1=X−X′0 is set (step S7). The analysis target data are updated by the objective variable d1 and the explanatory variable X1.

Next, a variable j=1 for counting the number of screenings is set (step S8).

It is determined whether the variable j is within a predetermined number of times value D_Iteration (step S9). When the variable j exceeds the predetermined number of times value D_Iteration, the processing ends. The processing of step S9 is performed by the number-of-times determination unit 17 of FIG. 4.

When the variable j is within the predetermined number of times value D_Iteration, the characteristic analysis unit 8 extracts characteristic data Xj and dj from the updated analysis target data (step S10).

Next, the screening processing unit 3 performs the screening processing based on the analysis target data and the characteristic data and generates the intermediate data X′j having the data size corresponding to the characteristic data (step S11).

Next, the second feature amount extraction unit 4b extracts the second feature amount X″j from the intermediate data X′j (step S12). Next, a linear prediction value Yj\hat{ } of the extracted second feature amount X″j is calculated (step S13). The linear prediction value Yj\hat{ } is a value obtained by multiplying the second feature amount X″j by a coefficient 131.

Next, the objective variable dj+1=dj−Yj\hat{ } is calculated (step S14). Next, the explanatory variable Xj+1=X−X′j is set (step S15).

Next, processing of the determination processing unit is performed (step S16). The determination processing unit determines whether to repeat the processings of steps S9 to S15, as will be described later.

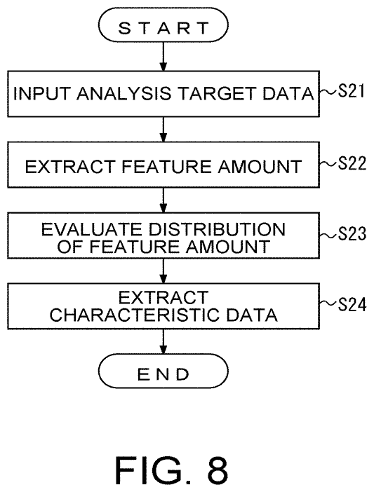

FIG. 8 is a detailed flowchart of processing procedures performed by the characteristic analysis unit 8 in steps S2 and S10 of FIG. 7.

First, the analysis target data including the explanatory variable X and the objective variable Y are input (step S21). Next, for example, a third feature amount is extracted using the Lasso's mathematical formula illustrated in the above formula (2) (step S22). The extraction of the third feature amount in this processing means to detect distribution characteristic of the analysis target data. The processing of step S22 is performed by the distribution detection unit 9 in FIG. 4.

Next, distribution of the third feature amount is evaluated (step S23). Here, for example, in order to calculate a ratio of the third feature amount to the explanatory variable X and a value of a regression coefficient for each third feature amount, and to extract the final third feature amount from the explanatory variable X, characteristic values such as how much screening is possible are calculated. The processing of step S23 is performed by the distribution evaluation unit 10 in FIG. 4.

Next, a correlation between the explanatory variable and the objective variable, for example, is calculated, and the characteristic data are extracted (step S24). From the distribution evaluation result of the third feature amount, for example, when there is a strong bias in distribution of the regression coefficient, it can be judged that the data after screening may be small. The processing of step S24 is performed by the correlation calculating unit 11 of FIG. 4.

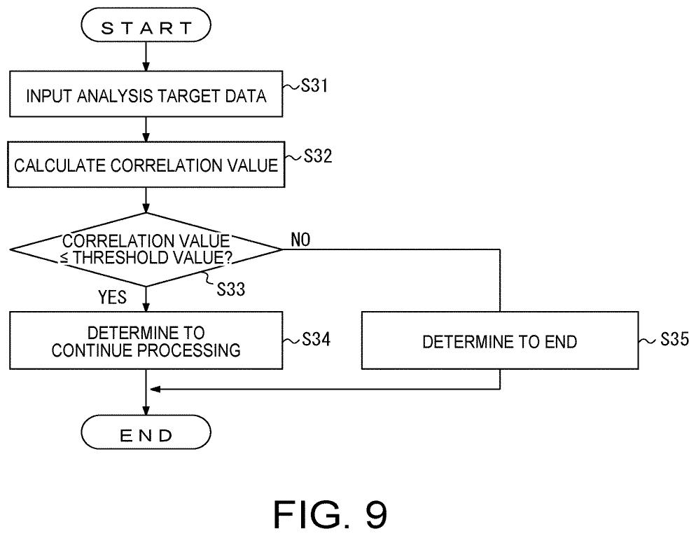

FIG. 9 is a detailed flowchart of the processing procedure performed by the determination processing unit in step S16 of FIG. 7. First, the analysis target data including the explanatory variable X and the objective variable Y are input (step S31). Next, the correlation value between the explanatory variable X and the objective variable Y is calculated (step S32). The processing of step S32 is performed by the correlation calculation unit 18 of FIG. 4.

Next, it is determined whether the correlation value is equal to or less than a predetermined threshold value (step S33). When the correlation value is equal to or less than the threshold value, it is determined that the processings of steps S9 to S17 in FIG. 7 should still be repeated (step S34). On the other hand, when the correlation value is larger than the threshold value, the processing of FIG. 7 is terminated. The processing of step S33 is performed by the correlation degree determination unit 19 of FIG. 4.

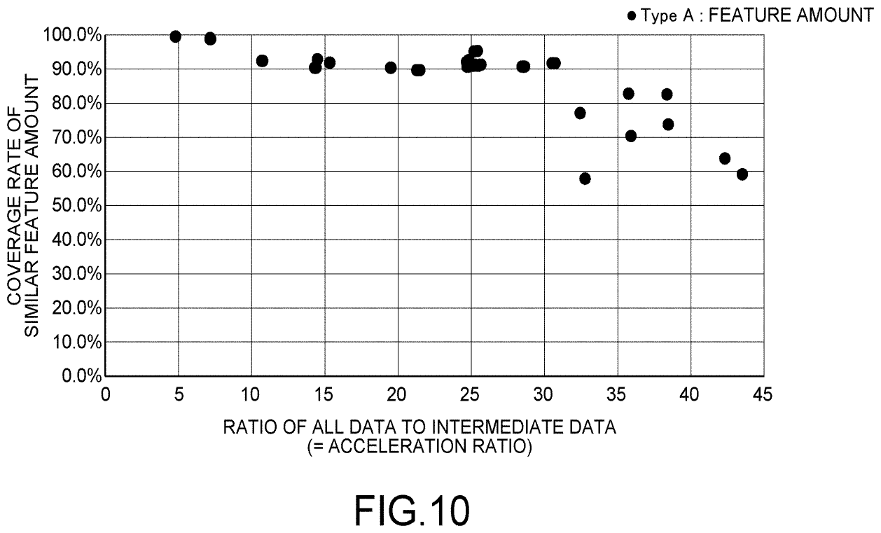

FIG. 10 is a diagram illustrating results of extracting similar feature amounts from big data related to a semiconductor process by the information processing device according to the second embodiment. A horizontal axis of FIG. 10 is a ratio of all data to the intermediate data, and a vertical axis is a coverage rate of similar feature amounts. The coverage rate of the similar feature amounts is a ratio of the similar feature amount extracted from the intermediate data to the similar feature amount extracted from the analysis target data. As illustrated in the drawing, even when the data size of the intermediate data is 1/25 of the analysis target data, a coverage rate of 90% or more was obtained, confirming effectiveness of the present embodiment.

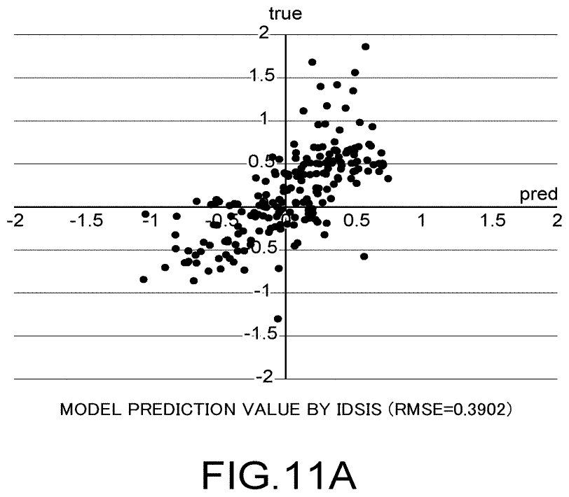

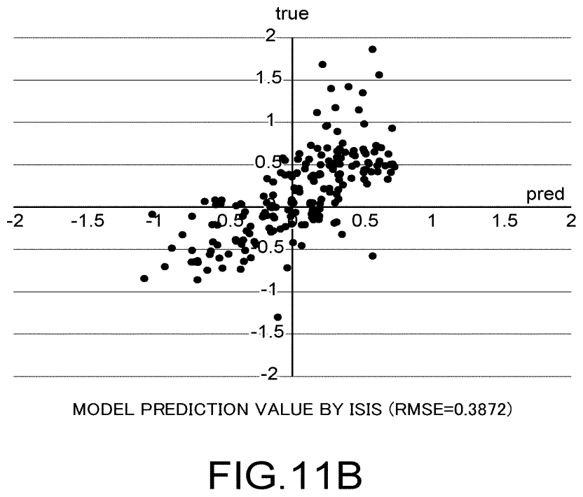

FIG. 11A is a diagram illustrating a model accuracy of a screening method (IDSIS) according to the present embodiment, and FIG. 11B is a diagram illustrating the model accuracy of ISIS for performing screening only once. FIGS. 11A and 11B represent plots where a predicted value pred is true. As can be seen by comparing FIGS. 11A and 11B, there is no change in model prediction value and Root Mean Square Error (RMSE), and the model accuracy is maintained by the screening method in FIG. 11A.

As described above, in the second embodiment, the screening processing is repeated a plurality of times, the intermediate data are generated for each screening processing, and the second feature amount is generated for each intermediate data. Based on the generated second feature amount, the analysis target data are updated to generate the next intermediate data. As a result, the analysis target data can be divided into small pieces, and the intermediate data can be generated in small pieces, and the individual intermediate data can be generated quickly. In addition, the first feature amount extraction unit 4a extracts the first feature amount based on all the intermediate data generated by the screening processing unit 3 in the multiple screening processings and examines which intermediate data of the screening processing unit 3 each of the extracted first feature amounts was extracted from. Then, the similar feature amount extraction unit 5 extracts the similar feature amount from the intermediate data from which each first feature amount is extracted. As a result, the range for extracting the similar feature amount can be narrowed, and the similar feature amount can be extracted at high speed.

At least a part of the information processing devices 1 and 1a described in the above-described embodiments may be configured by hardware or software. When configured by software, a program that realizes at least a part of the functions of the information processing device 1 may be stored in a recording medium such as a flexible disk or a CD-ROM, read by a computer, and executed. The recording medium is not limited to a removable medium such as a magnetic disk or an optical disk and may be a fixed recording medium such as a hard disk device or a memory.

In addition, a program that realizes at least a part of the functions of the information processing devices 1 and 1a may be distributed via a communication line (including wireless communication) such as the Internet. Further, the program may be distributed in a state of being encrypted, modulated, or compressed via a wired line or wireless line such as the Internet or after being stored in a recording medium.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

1. An information processing device comprising:
an inputter configured to input analysis target data including a plurality of explanatory variables;
a screening processor configured to generate intermediate data with the number of the explanatory variables included in the analysis target data reduced by using a part of the plurality of explanatory variables as objective variables;
a first feature amount extractor configured to extract a first feature amount from the intermediate data based on the objective variables; and
a similar feature amount extractor configured to extract a similar feature amount from the intermediate data based on a degree of similarity between the explanatory variables included in the intermediate data and the first feature amount.

2. The information processing device according to claim 1, wherein
the screening processor is configured to generate the intermediate data with a part of the explanatory variables deleted from the analysis target data so as not to lose the first feature amount.

3. The information processing device according to claim 1, comprising
a regression model constructor configured to construct a regression model that calculates the first feature amount by regression analysis of the objective variables and the intermediate data, wherein
the first feature amount extractor is configured to extract the first feature amount from the intermediate data based on the regression model.

4. The information processing device according to claim 1, comprising
a first designator configured to specify a size of the intermediate data.

5. The information processing device according to claim 1, comprising
a characteristic analyzer configured to extract characteristic data from the analysis target data, wherein the screening processor is configured to generate the intermediate data having a data size corresponding to the characteristic data based on the analysis target data and the characteristic data.

6. The information processing device according to claim 5, wherein
the characteristic analyzer comprises:
an explanatory variable distribution detector configured to detect distribution of explanatory variables included in the analysis target data;
a distribution evaluator configured to evaluate the distribution of the explanatory variables detected by the explanatory variable distribution detector; and
a correlation calculator configured to extract the characteristic data based on an evaluation result of the distribution evaluator.

7. The information processing device according to claim 6, comprising
a second designator configured to specify the characteristic data extracted by the characteristic analyzer.

8. The information processing device according to claim 1, wherein
the screening processor is configured to repeat processing of generating the intermediate data from the analysis target data a plurality of times,
the first feature amount extractor is configured to extract a plurality of the first feature amounts in association with the intermediate data a plurality of times after the screening processor finishes generating the intermediate data a plurality of times, and
the similar feature amount extractor is configured to extract the similar feature amount from the intermediate data corresponding to each of the plurality of first feature amounts.

9. The information processing device according to claim 8, comprising:
an objective variable updater configured to generate new objective variables each time the screening processor generates new intermediate data;
an explanatory variable updater configured to generate new explanatory variables each time the screening processor generates new intermediate data; and
an analysis target updater configured to update the analysis target data so as to include the new objective variables and the new explanatory variables, wherein
the screening processor is configured to generate new intermediate data from the updated analysis target data.

10. The information processing device according to claim 9, comprising:
a second feature amount extractor configured to extract a second feature amount based on the new intermediate data each time the screening processor generates the new intermediate data; and
a predictor configured to predict the objective variable based on the second feature amount, wherein
the objective variable updater is configured to generate the new objective variable by a difference between an original objective variable and the predicted objective variable.

11. The information processing device according to claim 10, comprising:
a number-of-times determinator configured to determine whether the number-of-times the second feature amount has been extracted by the second feature amount extractor has reached a predetermined number of times;
a correlation calculator configured to calculate a degree of correlation between the new objective variable and the new analysis target data when it is determined that the predetermined number of times has not been reached; and
a correlation degree determinator configured to determine whether the degree of correlation is equal to or higher than a predetermined threshold value, wherein
the screening processor is configured to end the generation of the intermediate data when the degree of correlation is equal to or higher than a predetermined threshold value, and stops the generation of the intermediate data when the degree of correlation is less than the threshold value.

12. The information processing device according to claim 9, wherein
the explanatory variable updater is configured to generate the new explanatory variable by a difference between an original explanatory variable and the explanatory variable included in the intermediate data.

13. The information processing device according to claim 8, comprising
a third designator configured to specify the number of times the screening processor generates the intermediate data.

14. The information processing device according to claim 8, comprising
a fourth designator configured to specify the explanatory variable to be selected each time the screening processor generates the intermediate data.

15. The information processing device according to claim 8, comprising
a fifth designator configured to specify a lower limit value of the explanatory variable included in the intermediate data each time the screening processor generates the intermediate data.

16. The information processing device according to claim 1, wherein
the similar feature amount extractor is configured to extract the similar feature amount from a part of the intermediate data based on the degree of similarity between the explanatory variable included in a part of the intermediate data and the first feature amount.

17. An information processing method comprising:
inputting analysis target data including a plurality of explanatory variables;
generating intermediate data with the number of the explanatory variables included in the analysis target data reduced by using a part of the plurality of explanatory variables as objective variables;
extracting a first feature amount from the intermediate data based on the objective variables; and
extracting a similar feature amount from the intermediate data based on a degree of similarity between the explanatory variables included in the intermediate data and the first feature amount.

18. The information processing method according to claim 17, wherein
the generating the intermediate data comprises generating the intermediate data with a part of the explanatory variables deleted from the analysis target data so as not to lose the first feature amount.

19. The information processing method according to claim 17, further comprising
constructing a regression model that calculates the first feature amount by regression analysis of the objective variables and the intermediate data, wherein
the extracting the first feature amount comprises extracting the first feature amount from the intermediate data based on the regression model.

20. The information processing method according to claim 17, comprising
extracting characteristic data from the analysis target data, wherein the generating the intermediate data comprises generating the intermediate data having a data size corresponding to the characteristic data based on the analysis target data and the characteristic data.
